(19) United States
(12) Patent Application Publication
(10) Pub. No.: US 2025/0094185 A1
(43) Pub. Date: Mar. 20, 2025

(54) PROVIDING DOMAIN NAME SERVICES FOR CONVERSATIONAL INTERFACE PLATFORMS

(71) Applicant: VeriSign, Inc., Reston, VA (US)

(72) Inventors: Sameer THAKAR, Leesburg, VA (US); Karthik SHYAMSUNDER, Winchester, VA (US); Ramachandra Rao SEETHIRAJU, Brambleton, VA (US); Kevin PIPER, Aldie, VA (US)

(73) Assignee: VeriSign, Inc., Reston, VA (US)

(21) Appl. No.: 18/891,933

(22) Filed: Sep. 20, 2024

Related U.S. Application Data
(60) Provisional application No. 63/539,533, filed on Sep. 20, 2023.

(51) Int. Cl. G06F 9/451; G06F 9/54; G06F 40/143; G06F 40/40

(52) U.S. Cl. CPC G06F 9/451; G06F 9/547; G06F 40/143; G06F 40/40

(57) ABSTRACT

Examples described herein provide a computer-implemented method for providing domain name services for a conversational interface platform is provided. The computer-implemented method includes receiving, from the conversational interface platform at a domain name service system, information about a prompt that relates to a domain name service. The computer-implemented method further includes analyzing, by the domain name service system, the information about the prompt that relates to the domain name service. The computer-implemented method further includes generating, by the domain name service system, a response to the prompt that relates to the domain name service. The computer-implemented method further includes transmitting, from the domain name service system to the conversational interface platform, the response to the prompt that relates to the domain name service.

### CROSS REFERENCE TO RELATED APPLICATIONS

This application claims the benefit of the U.S. Patent Application No. 63/539,533, filed Sep. 20, 2023, which is incorporated herein by reference.

### BACKGROUND

A domain name system (DNS) may be considered, for example, to be a hierarchical distributed naming system for computers and computer-based services and resources connected to the Internet or a private network. A DNS allows people using the Internet to refer to domain names, rather than Internet protocol (IP) addresses, when accessing websites and other online services. Domain names can include characters such as letters, numbers, and hyphens, and can often be easier to remember than IP addresses. As an example, it may be easier for a user to remember a domain name, such as www.example.com, than an IP address, such as 93.184. 216.34.

Each domain name can be made up of a series of character strings (e.g., labels) separated by dots. The right-most label in a domain name is known as the top-level domain (“TLD”). Examples of well-known TLDs are “com”; “net”; “org”; and the like. Each TLD supports second-level domains, listed immediately to the left of the TLD, e.g., the “example” level in “www.example.com.” Each second-level domain can include a number of third-level domains located immediately to the left of the second-level domain, e.g., the “www” level in www.example.com.

A registry operator maintains a registry of second-level domains within the TLD. The registry is used for answering (or “resolving”) queries for IP addresses associated with domains, typically through DNS servers that maintain such information in large databases. A domain name may be registered with a registry through a registrar, an entity authorized to register domain names on behalf of registrants (e.g., end users). A registrar may communicate with the registrant directly, or the registrar may communicate with the registrant indirectly through one or more layers of resellers.

### SUMMARY

In one embodiment, a computer-implemented method for providing domain name services for a conversational interface platform is provided. The computer-implemented method includes receiving, from the conversational interface platform at a domain name service system, information about a prompt that relates to a domain name service. The computer-implemented method further includes analyzing, by the domain name service system, the information about the prompt that relates to the domain name service. The computer-implemented method further includes generating, by the domain name service system, a response to the prompt that relates to the domain name service. The computer-implemented method further includes transmitting, from the domain name service system to the conversational interface platform, the response to the prompt that relates to the domain name service.

In addition to one or more of the features described herein, or as an alternative, further embodiments of the computer-implemented method may include that the domain name service system is a domain name system (DNS) service provider plugin application programming interface (API).

In addition to one or more of the features described herein, or as an alternative, further embodiments of the computer-implemented method may include that the domain name service system comprises a multi-modal request handler to parse, aggregate, and consolidate the information about the prompt that relates to the domain name service and generate a parsed, aggregated, and consolidated output.

In addition to one or more of the features described herein, or as an alternative, further embodiments of the computer-implemented method may include that the domain name service system comprises a context facilitator to evaluate and supplement a context of the prompt.

In addition to one or more of the features described herein, or as an alternative, further embodiments of the computer-implemented method may include that the context facilitator uses a context builder to build additional context to supplement the context responsive to a determination that the context is insufficient.

In addition to one or more of the features described herein, or as an alternative, further embodiments of the computer-implemented method may include that the context builder uses a large language model or a dataset to build the additional context to supplement the context.

In addition to one or more of the features described herein, or as an alternative, further embodiments of the computer-implemented method may include that the domain name service system comprises a suggestion algorithm picker to select a suggestion algorithm from a plurality of selection algorithms, wherein the selection is based on a context of the prompt.

In addition to one or more of the features described herein, or as an alternative, further embodiments of the computer-implemented method may include that the domain name service system uses the selected suggestion algorithm to call a domain name search application programming interface (API) to perform an operation associated with the prompt.

In addition to one or more of the features described herein, or as an alternative, further embodiments of the computer-implemented method may include that the operation is selected from a group consisting of searching for a domain name, generating a logo, and suggesting a large language model.

In addition to one or more of the features described herein, or as an alternative, further embodiments of the computer-implemented method may include that the domain name service system comprises a multi-modal response handler to generate a multi-modal response to the conversational interface platform, where the conversational interface platform generates a conversational response based on the response from the multi-modal response handler.

In another embodiment, a system is provided. The system includes a memory comprising computer readable instructions. The system further includes a processing device for executing the computer readable instructions, the computer readable instructions controlling the processing device to perform operations for providing domain name services for a conversational interface platform. The operations include receiving, from the conversational interface platform at a domain name service system, information about a prompt that relates to a domain name service. The operations further include analyzing, by the domain name service system, the information about the prompt that relates to the domain name service. The operations further include generating, by the domain name service system, a response to the prompt that relates to the domain name service. The operations further include transmitting, from the domain name service system to the conversational interface platform, the response to the prompt that relates to the domain name service.

In addition to one or more of the features described herein, or as an alternative, further embodiments of the system may include that the domain name service system comprises: a multi-modal request handler to parse, aggregate, and consolidate the information about the prompt that relates to the domain name service and generate a parsed, aggregated, and consolidated output; a context facilitator to evaluate and supplement a context of the prompt; a suggestion algorithm picker to select a suggestion algorithm from a plurality of selection algorithms, wherein the selection is based on the context of the prompt; and a multi-modal response handler to generate a multi-modal response to the conversational interface platform, where the conversational interface platform generates a conversational response based on the response from the multi-modal response handler.

In addition to one or more of the features described herein, or as an alternative, further embodiments of the system may include that the context facilitator uses a context builder to build additional context to supplement the context responsive to a determination that the context is insufficient.

In addition to one or more of the features described herein, or as an alternative, further embodiments of the system may include that the context builder uses a large language model or a dataset to build the additional context to supplement the context.

In addition to one or more of the features described herein, or as an alternative, further embodiments of the system may include that the domain name service system uses the selected suggestion algorithm to call a domain name search application programming interface (API) to perform an operation associated with the prompt, wherein the operation is selected from a group consisting of searching for a domain name, generating a logo, and suggesting a large language model.

In yet another embodiment, a computer-implemented method for providing domain name services for a conversational interface platform is provided. The computer-implemented method includes receiving, at the conversational interface platform from a user, a prompt relating to a domain name service. The computer-implemented method further includes providing, by the conversational interface platform to a domain name service system, information about the prompt that relates to the domain name service. The computer-implemented method further includes receiving, by the conversational interface platform from the domain name service system, a response to the prompt that relates to the domain name service. The computer-implemented method further includes presenting, by the conversational interface platform, the response to the prompt that relates to the domain name service as a conversational response.

In addition to one or more of the features described herein, or as an alternative, further embodiments of the computer-implemented method may include that the prompt is selected from a group consisting of a request to register a domain name, a request for recommendations for a domain name, and a request for information about a domain name.

In addition to one or more of the features described herein, or as an alternative, further embodiments of the computer-implemented method may include that the information about the prompt that relates to the domain name service includes the prompt itself.

In addition to one or more of the features described herein, or as an alternative, further embodiments of the computer-implemented method may include that the information about the prompt that relates to the domain name service includes information extracted from or generated based on the prompt but not the prompt itself.

In addition to one or more of the features described herein, or as an alternative, further embodiments of the computer-implemented method may include that the conversational interface platform generates the conversational response based at least in part on the prompt related to the domain name service and the response to the prompt related to the domain name service.

In yet another embodiment, a computer-implemented method for providing domain name services for a conversational interface platform is provided. The computer-implemented method includes receiving, from the conversational interface platform at a domain name service system, information about a prompt that relates to a domain name service. The computer-implemented method further includes analyzing, by the domain name service system, the information about the prompt that relates to the domain name service. The computer-implemented method further includes determining whether to obtain contextual information about the prompt. The computer-implemented method further includes obtaining contextual information about the prompt. The computer-implemented method further includes generating, by the domain name service system, a response to the prompt that relates to the domain name service and the obtained contextual information. The computer-implemented method further includes transmitting, from the domain name service system to the conversational interface platform, the response to the prompt that relates to the domain name service.

In yet another embodiment, a method, machine, manufacture, and/or system is provided substantially as shown and described.

The above features and advantages, and other features and advantages, of the disclosure are readily apparent from the following detailed description when taken in connection with the accompanying drawings.

### BRIEF DESCRIPTION OF THE DRAWINGS

FIG. 1 depicts a block diagram of a system for providing domain name services for a conversational interface platform according to one or more embodiments described herein.

FIG. 2 depicts a block diagram of a system for providing domain name services for a conversational interface platform according to one or more embodiments described herein.

FIGS. 3A and 3B (collectively FIG. 3) depict a block diagram of a system for providing domain name services for the conversational interface platform of FIG. 1 according to one or more embodiments described herein.

FIG. 4 depicts an interface for interacting with a conversational interface platform that supports providing domain name services according to one or more embodiments described herein.

FIG. 5 depicts a flow diagram of a method for providing domain name services for a conversational interface platform according to one or more embodiments described herein.

FIG. 6 depicts a flow diagram of a method for providing domain name services for a conversational interface platform according to one or more embodiments described herein.

FIG. 7 depicts an example computer apparatus.

### DESCRIPTION OF EMBODIMENTS

This application describes embodiments for providing domain name services for conversational interface platforms. Many DNS service providers offer domain name services to users. DNS service providers offer domain name services to internet users and/or domain name registrants. For example, when a user desires to register a domain name, the user requests a registrar to register the domain name on the user's behalf. In turn, the registrar registers the domain name on behalf of the user (now a registrant) with a registry. This registrar becomes the registrar of record as indicated in the registry for the domain name. DNS service providers may provide other types of DNS services or DNS-related services, such as checking domain name availability, suggesting alternate domain names when a domain name is not available to be registered, suggesting domain names, performing domain name lifecycle services (e.g., registering domain names, updating domain name information, deleting domain name information, renewing domain names, listing domain names, providing information about domain names), and/or the like including combinations and/or multiples thereof. In some cases, a DNS service provider may represent a collection of two or more entities (e.g., a registry and a registrar) that together provide DNS-related services. In other cases, a DNS service provider may represent a single entity that provides DNS-related services, such as a registry or a registrar. In yet other cases, a DNS service provider may be a registrar, but not the registrar of record for a particular domain name.

Typically, when a user wants to interact with a DNS service provider to perform DNS-related services, the user interacts with the DNS service provider directly. For example, the registrant navigates to a website of a registrar and requests the DNS-related services, such as domain name registration or services related to a domain name registered to registrant (where the registrar is the registrar of record) via the registrar website. However, in some cases, a user may not know what DNS-related services to request, what DNS servicer provider to use, or how to interact with the DNS service provider.

One or more embodiments described herein address these and other shortcomings by providing DNS-related services via a conversational interface platform. A conversational interface platform enables a user to interact with software applications as if the user was interacting with a real person rather than a computer. For example, a user can enter a “prompt” in natural language, which the conversational interface platform can analyze to determine the user's intended meaning, for example, using natural language processing and machine learning, and/or the like including combinations and/or multiples thereof. The conversational interface platform can then generate a response in a conversational form to the user. Conversational interface platforms often use trained machine learning models, such as large language models (LLMs). An LLM is an artificial intelligence (AI) algorithm that uses deep learning and large data sets to analyze and understand user prompts and to generate responses thereto. LLMs are often trained to generate responses in a human-like, conversational manner. LLMs can be used for natural language processing, chatbots and virtual assistants, content generation, language translation, and/or the like including combinations and/or multiples thereof. Examples of conversational interface platforms include, but are not limited to: Chat Generative Pre-trained Transformer (ChatGPT) powered by OPENAI GPT; Bard powered by GOOGLE, INC. Pathways Language Model (PaLM); among others.

One drawback of current LLMs is that they are trained on a static dataset which is relevant only to a certain period of time. Accordingly, LLMs typically do not have the ability to provide real-time or near-real time data. For example, if a user prompts a conversational interface platform to provide the current or real-time registration status or record(s) of a particular domain name, the conversational interface platform cannot provide this information solely using a trained LLM.

To address this and other shortcomings of conversational interface platforms, one or more embodiments described herein provides a plugin or interface for providing domain name services. For example, a conversational interface platform can fine-tune its LLM(s) to provide specific functionality and/or to integrate third-party services. According to one or more embodiments described herein, an LLM can interact with third-party services, such as a provider of domain name services, a DNS service provider, or other domain name related service provider, using an API with endpoints for the LLM to call. This enables conversational interface platforms that use LLMs to provide domain name services to users for completing domain name or DNS-related tasks or answering domain name or DNS-related questions that the LLM may not otherwise be able to address. According to one or more embodiments described herein, domain name services can be provided via conversational interface platforms so that users can have domain name services fulfilled.

Non-limiting examples of domain name services, such as those provided by a DNS service provider, include checking domain name availability, suggesting domain names or alternate domain names, performing domain name lifecycle services (e.g., registering domain names, updating domain name information, deleting domain name information, renewing domain name registration, transferring domain name registration), providing information about domain names (e.g., WHOIS data, registration data access protocol (RDAP) data), and/or the like including combinations and/or multiples thereof. In some cases, a DNS service provider, as used herein, represents a collection of two or more entities (e.g., a registry and a registrar) that together provide DNS-related services. In other cases, a DNS service provider, as used herein, represents a single entity (e.g., a registry or a registrar) that provides DNS-related services.

The embodiments described herein further provide a practical application to generate responses to user prompts that relate to performing DNS-related services, such as suggesting or registering domain names. For example, existing conversational interface systems do not natively support DNS-related inquiries because the LLMs that enable conversational interface systems do not have access to real-time DNS data used to perform DNS-related services. Accordingly, the functionality of existing conversational interface systems, like ChatGPT, are improved by adding functionality to those systems. Further, accessing the large amounts of data involved in DNS-related services and processing requests for DNS-related services quickly cannot be performed in the human mind. Instead, an electronic computing device(s) (e.g., a computer apparatus(es) having at least one processor) is needed to implement the inventive techniques, provide computational speed, computational accuracy, and data management.

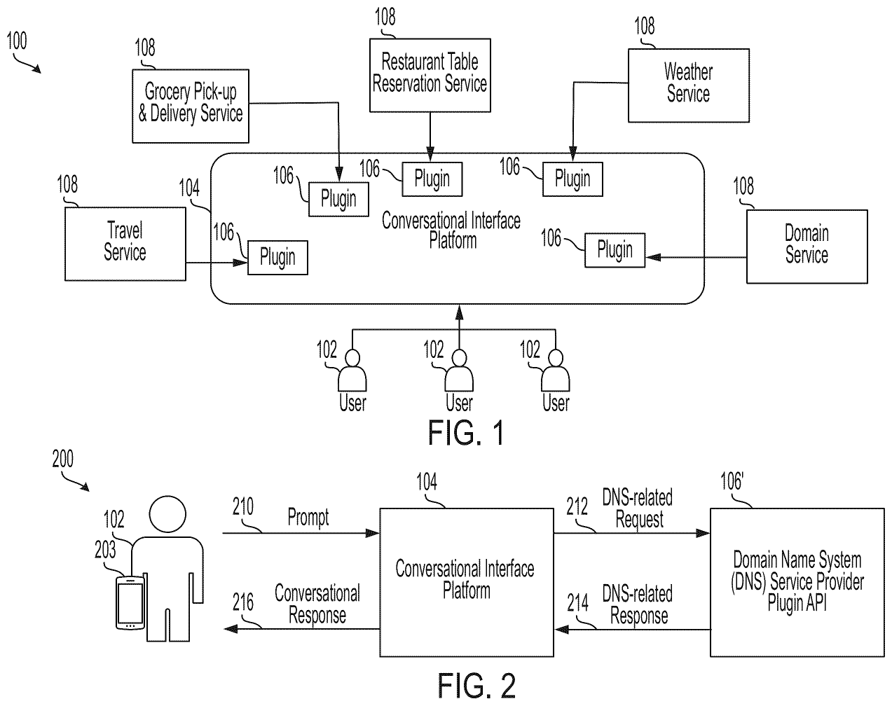

FIG. 1 depicts a block diagram of a conversational interface platform 104 for providing conversational responses to one or more users 102 according to one or more embodiments described herein. In this example, the conversational interface platform 104 supports multiple interfaces or plugins 106 that enable the conversational interface platform 104 to interact with third-party providers 108. Each of the plugins 106 can vary in functionality depending, for example, on the particular third-party provider and/or the particular conversational interface platform 104. Examples of third-party providers 108 include, but are not limited to, a travel service, a grocery pick-up and delivery service, a restaurant table reservation service, a weather service, and a DNS domain service.

One or more embodiments described herein support both vertically integrated registries and model-based registries. For example, according to one or more embodiments described herein, the conversational interface platform 104 is vertically integrated and a DNS registry operator can provide domain life cycle services directly to the user 102 (e.g., a registrant, registrar, or other type of user) of the conversational interface platform 104. According to one or more embodiments described herein, a DNS registry may have to comply with certain standards or models (e.g., the Internet Corporation for Assigned Names and Numbers (ICANN) registrant, registrar, and registry (RRR) model) in which case the DNS registry may not provide domain services directly to registrants. In such cases, participating entities can be listed and integrated so that the user 102 can communicate with the registry, registrar, registration data service, and/or other domain name service provider of the user's choice to receive domain life cycle services or other domain name service via the conversational interface platform 104.

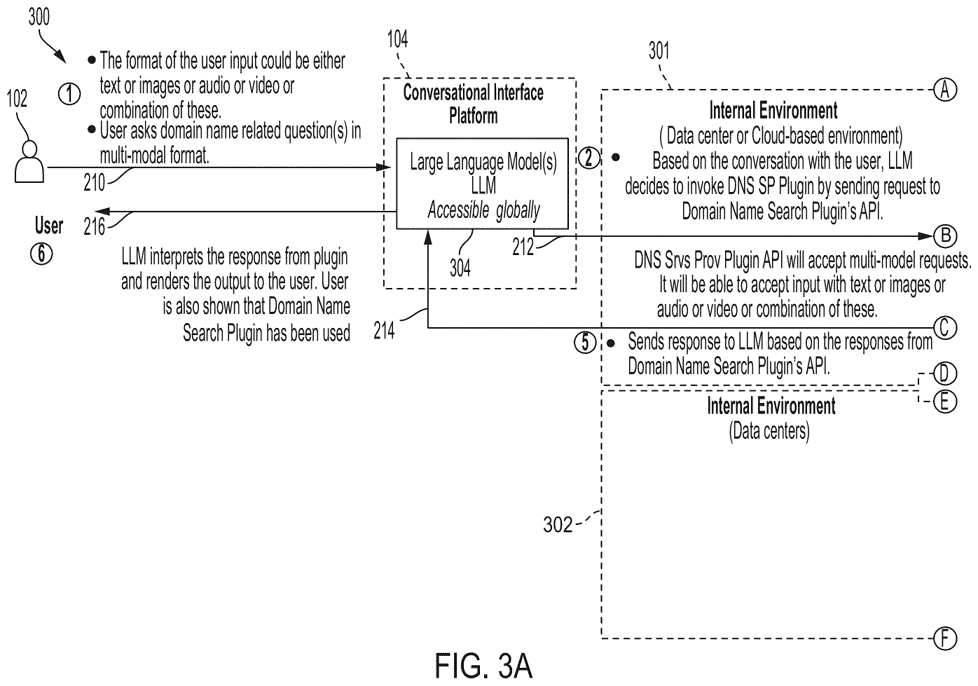

FIG. 2 depicts a block diagram of system 200 for providing domain name services for the conversational interface platform 104 of FIG. 1 according to one or more embodiments described herein. The system 200 may include the conversational interface platform 104 and a DNS service provider plugin application programming interface (API) 106′ (also referred to as a “domain name service system”), which is an example of one of the plugins 106 of FIG. 1. The conversational interface platform 104 receives a prompt 210 from the user 102. The user 102 can enter the prompt 210 as text, video, audio, and/or the like including combinations and/or multiples thereof, using a user device 203 associated with the user 102. The prompt 210 relates (either directly or indirectly) to a domain name or domain name service. As an example of a prompt that directly relates to a domain name service, the prompt 210 could be a request to register a new domain name (e.g., “Identify and register a domain name for a new bakery called ‘Vegan Cupcakes’.”). An example of a prompt that indirectly relates to the domain name service is a request that does not specifically request a domain name service but may be supported by providing a domain name service (e.g., “I'm starting a new bakery that sells vegan cupcakes. What steps can I take to make my new business a success?”, where the conversational interface platform 104 determines a domain name suggestion should be provided to the user and a response to the prompt invokes a domain name service to suggest one or more domain names to the user).

The conversational interface platform 104 invokes the DNS service provider (e.g., an entity that provides domain name services) plugin API 106′ by sending a DNS-related request 212 to the DNS service provider plugin API 106′. The DNS service provider plugin API 106′ analyzes the DNS-related request 212 and generates a DNS-related response 214, which is transmitted back to the conversational interface platform 104. The conversational interface platform 104 uses the DNS-related response 214 to generate a conversational response 216 (e.g., “Here are some domain name suggestions” with a list of suggestions), which is presented to the user 102, such as on a display or as an audio output of the user device 203.

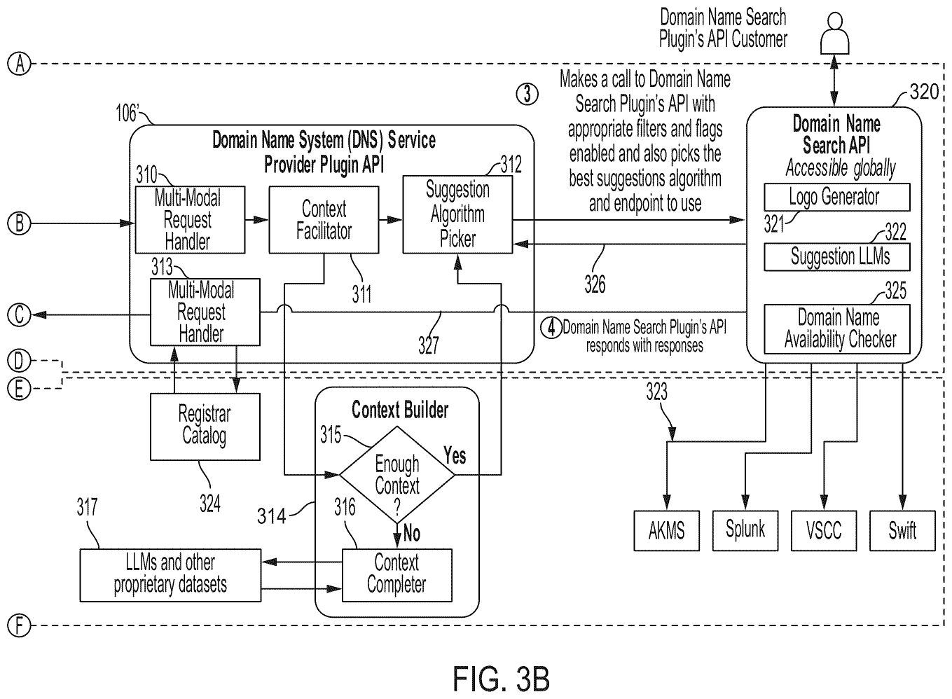

FIG. 3 depicts a block diagram of system 300 for providing domain name services for the conversational interface platform 104 of FIG. 1 according to one or more embodiments described herein. The system 300 represents a more detailed embodiment of the system 200 of FIG. 2 according to an embodiment.

The user 102 sends the prompt 210 to the conversational interface platform 104 as described herein. The user may ask a question, such as a domain related question(s) or a question from which the conversational interface platform 104 infers or determines that a domain related response to user is appropriate. The question may be in a multi-modal format. The multi-modal format of the user input may be text, image(s), audio, video, media, digital file(s) and/or the like including combinations and/or multiples thereof.

In the embodiment of FIG. 3, the conversational interface platform 104 uses a LLM 304 (such as, for example, ChatGPT, Bard, PaLM, or any other suitable LLM or conversational interface platform), which receives the prompt 210 from the user. It should be appreciated that any suitable LLM or conversational interface platform can be used, and the present description is not limited to a particular LLM or conversational interface platform unless otherwise noted. The LLM 304 sends the DNS-related request 212 (which can include the prompt 210 and/or information about the prompt 210) to the DNS service provider plugin API 106′. As an example, the LLM 304 decides whether to invoke the DNS service provider plugin API 106′ and then sends the DNS-related request 212 to the DNS service provider plugin API 106′. For example, the LLM 304 may decide to invoke the DNS service provider plugin API 106′ when the DNS service provider plugin API 106′ is available and enabled and when the prompt 210 directly or indirectly relates to a domain name service. According to one or more embodiments described herein, the DNS service provider plugin API 106′ can accept multi-modal requests and/or can accept input with text, image(s), audio, video, media, digital file(s), and/or the like including combinations and/or multiples thereof.

According to one or more embodiments described herein, components of the DNS service provider plugin API 106′ include a multi-modal request handler 310, a context facilitator 311, a suggestion algorithm picker 312, and a multi-modal response handler 313.

The multi-modal request handler 310 receives an input from the LLM 304, which may be a multi-modal input. The multi-modal request handler 310 parses, aggregates, and/or consolidates the received inputs (e.g., the information about the prompt that relates to the domain name service) and generates a parsed, aggregated, and consolidated output. For example, the multi-modal request handler 310 can extract information from the input, such as text from audio inputs, images/text from video inputs, etc. The multi-modal request handler 310 can determine context associated with the input. The multi-modal request handler 310 outputs the extracted information and associated context. The context is any kind of data that is used to suggest a meaningful and contextual solution. The context provides information about the prompt that may or may not be directly included in the prompt. For example, the context can indicate information about the user 102 (e.g., a location of the user 102), information about the prompt 210 (e.g., a language of the prompt 210), and/or the like including combinations and/or multiples thereof. The context is useful for performing domain name services. In some cases, the context is derived directly from the prompt 210. In other cases, the context is determined using other sources of information. For example, the prompt 210 may not indicate a geographic location of the user; however, information about the geographic location of the user 102 can be determined from other sources, such as based on an Internet protocol (IP) address associated with the user device 203, or context inferred from other context derived from the prompt 210. According to an embodiment, the user 102 may authenticate itself to the DNS service provider plugin API 106′, so that the DNS service provider plugin API 106′ can log the user session to determine context from the user logs and/or user authentication information or profile. The following list provides non-limiting examples of context parameters: keywords; for personal, email address, first name, last name, short name; for business, description, organization (e.g., small business, nonprofit, personal, company, etc.), organization category (e.g., clothing, restaurant, etc.); online presence; social handles; target audience; location/region; demographics; images; speech; language; email; minimum length of a domain name; maximum length of a domain name; use of dashes or hyphens in a domain name; and/or the like including combinations and/or multiples thereof. According to one or more embodiments described herein, the DNS service provider plugin API 106′ can indicate to the conversational interface platform 104 what context the DNS service provider plugin API 106′ can accept and use. In some cases, the conversational interface platform 104 may use the knowledge of what context can be accepted to query the user 102 to provide some of the context directly.

According to one or more embodiments described herein, the DNS service provider plugin API 106′ communicates to the conversational interface platform 104 what context parameters the DNS service provider plugin API 106′ can accept and/or what context parameters are desired (or, in some embodiments, conversational interface platform 104 may determine what context parameters the DNS service provider plugin API 106′ can accept and/or what context parameters are desired based on characteristics or parameters advertised by the DNS service provider plugin API 106′). In some examples, the conversational interface platform 104 extracts information from the prompt 210 and sends that information about the prompt 210 to the DNS service provider plugin API 106′. In another example, the conversational interface platform 104 sends the prompt 210 directly to the DNS service provider plugin API 106′. In yet another example, the conversational interface platform 104 sends the prompt 210 and the information extracted from the prompt 210 to the DNS service provider plugin API 106′. In some embodiments, the DNS service provider plugin API 106′ can send a request for more information to the conversational interface platform 104, such as if not enough context is available, as described herein.

The context facilitator 311 may determine context or determine additional context to fill a determined contextual gap in the DNS-related request 212 (which can include the prompt 210 and/or information about the prompt 210). For example, the context facilitator 311 converts the context from the multi-modal request handler 310 to a format consumable by a context builder 314 and assists in evaluating and supplementing the context. The context facilitator 311 acts as an intermediary between the context facilitator and the suggestion algorithm picker 312.

The context builder 314 determines whether the output of the multi-modal request handler 310 includes enough context at block 315. That is, the context builder 314 determines whether the parsed, aggregated, and consolidated output from the multi-modal request handler 310 is contextual enough to provide a relevant response to the prompt 210. It may be determined that enough context exists, for example, if at least a predetermined number of context parameters are present or if a certain number of context parameters are present. In another example, context parameters can be weighted with certain context parameters having relatively higher weightings than other context parameters having relatively lower weightings. The context may be considered sufficient if a threshold weighting amount of context parameters are present. For example, if a single context parameter has a weighting value above the threshold, the context is considered sufficient. Similarly, if multiple context parameters collectively have weighting values above the threshold, the context is considered sufficient. Other techniques for determining whether the context is sufficient are possible.

According to one or more embodiments described herein, the weighting can be set statically (e.g., a user request has a higher weighting than geographic location). According to one or more embodiments described herein, the weighting can be dynamic and can change depending upon, for example, the prompt 210. For example, the prompt “I'd like a domain name with a hyphen and in Spanish or French, but French is more important” can be used to dynamically adjust the weighting where a context parameter for the language French has a higher weighting than a context parameter for the language Spanish. As another example, the weighting can be based on preferences of groups of users. For example, if it is known that users in a certain area prefer domain names having a hyphen between two words (e.g., “acme-company.com) rather than the words being connected together without a space (e.g., “acmecompany.com”), a context parameter with the geographic location of the user can be used to weight a context parameter indicating to use hyphens. Other types of dynamic weighting are also possible. Suggestion algorithm picker 312 may determine or tune an algorithm based on the weightings of the context parameters (whether determined from the prompt 210, information about the prompt 210, and/or from context determined from context builder 314), for example, to make a call to the domain name search API.

Consider the following example: Assume the user 102 wants domain name suggestions for “vegan cupcakes” (determined from the prompt 210). In this case, only two words of context are available: “vegan” and “cupcakes.” The context facilitator 311 and/or the context builder 314 may try to understand if any of the other input parameters can be filled in. For example, since the prompt 210 is input in English, a language context parameter can be set to “English.” As another example, if the prompt 210 originated from an IP address in the United States, a region context parameter can be set to “United States.” This approach enables additional context to be added to the prompt 210.

If it is determined that not enough context is available (e.g., the context is insufficient) at block 315, a context completer 316 of the context builder 314 can assist with building and completing the context. Building and completing the context can include using additional sources of data 317, such as LLMs (e.g., including information obtained from one or more interactions with LLM 304, other LLM(s), or other conversational interface platform(s)) and/or other proprietary datasets. For example, data about similar users can be used by the context completer 316 to build context for the prompt 210 for the user 102, where similarity can be determined using available context parameters. Other LLMs can be used to generate additional context parameters based on the available context parameters, and the generated additional context parameters can be used by the context completer to build context.

If it is determined that enough context is available (e.g., the context is sufficient), the suggestion algorithm picker uses the context to select a suitable suggestion algorithm from a plurality of suggestion algorithms, a suitable endpoint from a plurality of end points, and suitable filters and flags from a plurality of filters and flags. The plurality of suggestion algorithms, plurality of end points, and the plurality of filters and flags are based on available choices provided by a domain name search API 320. The domain name search API 320 is used to provide one or more suggested domain names using one or more of the plurality of suggestion algorithms. The plurality of suggestion algorithms each return suggested domain names based on input criteria (e.g., the context parameters, weighted context parameters, etc.). As an example, one suggestion algorithm may be selected for suggesting domain names in one geographic region where a different suggestion algorithm may be selected for suggesting domain names in another geographic region. The suggestion algorithm picker 312 can select which suggestion algorithm the domain name search API 320 uses.

According to one or more embodiments described herein, the domain name search API 320 can perform operations other than or in addition to providing suggested domain names. For example, the domain name search API 320 can generate a logo using a logo generator 321. For example, the domain name search API 320 can integrate or access an LLM based image generation tool (e.g., the logo generator 321). The domain name search API 320 can use the context from the DNS service provider plugin API 106′ as input to the logo generator 321, which generates a logo based on the context. As another example, the domain name search API 320 can suggest an LLM using the LLM suggester 322 to select from one or more possible LLMs 323. The LLM suggester 322 can suggest an LLM specialized or fine-tuned for domain name suggestions, for example.

According to one or more embodiments, the domain name search API 320 can determine whether the suggested domain names are available to be registered. If the domain name search API 320 determines that a suggested domain name is not available to be registered, the domain name search API 320 can suggest one or more alternate domain names using a same suggestion algorithm or a different suggestion algorithm. The suggested domain names can be initially suggested by the domain name search API 320 using one or more suggestion algorithms determined by the suggestion algorithm picker 312 or can be initially suggested by the user 102. For example, the domain name search API 320 can include a domain name availability checker 325 to determine whether a domain name suggested by a suggestion algorithm determined by the suggestion algorithm picker 312 is available to be registered. The domain name availability checker 325 can check domain name availability via a backend call. A backend call can refer to a message sent to the domain name availability checker 325 asking for checking a domain name availability from the backend, which is not visible or accessible to a user 102.

If the domain name availability checker 325 determines that the suggested domain name is not available to be registered, the domain name availability checker 325 can generate a feedback 326 and send the feedback 326 to one or more suggestion algorithms included in the domain name search API 320. The same suggestion algorithm that generated the unavailable domain name or a different suggestion algorithm from the one or more suggestion algorithms can be selected by the domain name search API 320 to generate an alternate domain name based on the feedback 326. The selected suggestion algorithm can send the alternate domain name to the domain name availability checker 325 for checking availability. This process can be repeated until the domain name availability checker 325 determines that a suggested domain name is available to be registered. The process (e.g., suggesting a domain name and/or checking an availability of a suggested domain name) can be performed via a backend call from the DNS service provider plugin API 106′. In some embodiments, the domain name availability checker 325 can send the feedback 326 to the suggestion algorithm picker 312. The suggestion algorithm picker 312 can determine one or more suggestion algorithms that are different from the ones used in the domain name search API 320 based on the feedback 326 and provide the newly determined one or more suggestion algorithms to the domain name search API 320. The domain name search API 320 can update the suggestion algorithms by adding the newly determined one or more suggestion algorithms to the old one or more suggestion algorithms or replacing the old one or more suggestion algorithms with the newly determined one or more suggestion algorithms.

Once the domain name search API 320 completes an operation (e.g., suggests a domain name, generates a logo, suggests an LLM, and/or the like including combinations and/or multiples thereof), the domain name search API 320 returns a response 327 to the multi-modal response handler 313 of the DNS service provider plugin API 106′.

The multi-modal response handler 313 takes the response from the domain name search API 320 and generates a response (e.g., the DNS-related response 214), which is sent to the conversational interface platform 104. For example, the multi-modal response handler 313 can generate responses in a multi-model format that can include text, links, images, code, video, animation, and/or the like including combinations and/or multiples thereof. For example, the multi-modal response handler 313 can generate responses that include domain name suggestions, domain name availability, description of a business, tag line for a business, registration links to registrars for domain name registration based on the context, business logos, sample code for a website, marketing content, and/or the like including combinations and/or multiples thereof. In the case of registration links, if the context indicates that the prompt generated from a customer located in a specific region, appropriate registrars for that region are shown. The registrars can be selected from a registrar catalog 324, for example.

The multi-modal response handler 313 sends the response (e.g., the DNS-related response 214) to the conversational interface platform 104. The conversational interface platform 104 then generates the conversational response 216 based on the response from the multi-modal response handler 313. For example, the LLM 304 interprets the response from the multi-modal response handler 313 of the DNS service provider plugin API 106′ and renders the conversational response, which is presented to the user 102. According to one or more embodiments described herein, the user 102 is also shown that the DNS service provider plugin API 106′ was used.

It should be appreciated that various possible implementations of the components shown in FIG. 3 are possible. As one possible implementation, the system 300 can be configured and arranged as shown. In this example, the DNS service provider plugin API 106′ and the domain name search API 320 reside in an internal environment 301 that can be maintained on the DNS provider's data center or a cloud-based environment. Certain components, such as the context builder, the other sources of data 317, the registrar catalog 324, and/or the like including combinations and/or multiples thereof, can reside in an internal environment 302 of the DNS provider. The conversational interface platform 104 can reside on another environment, such as a publicly-accessible third-party environment. Other implementations are also possible.

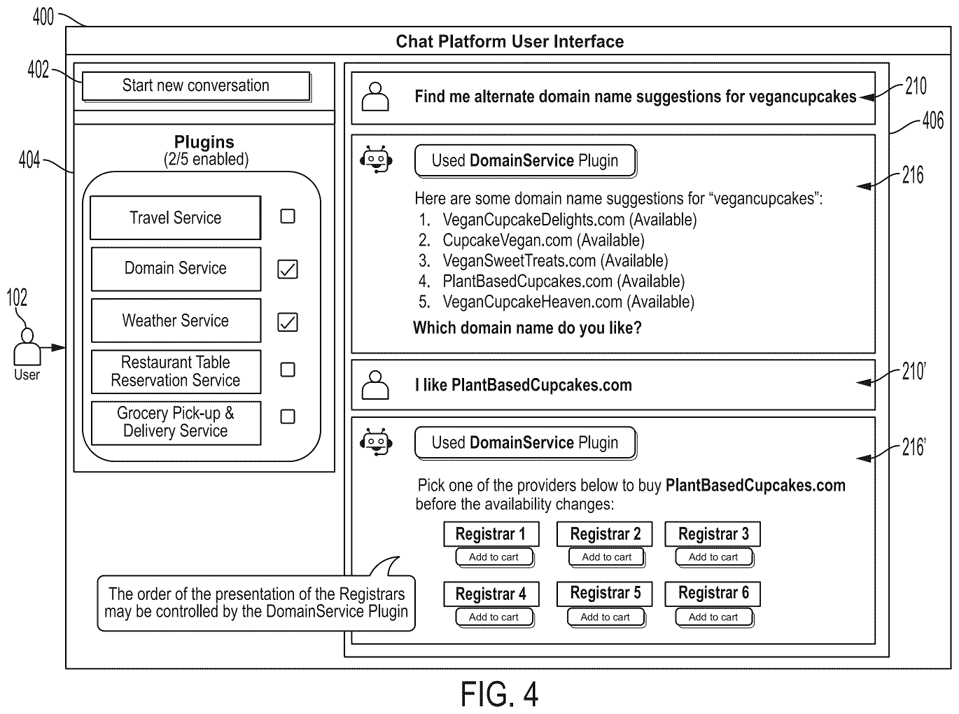

FIG. 4 depicts an interface 400 for interacting with a conversational interface platform that supports providing domain name services according to one or more embodiments described herein. In particular, the interface 400 can be rendered by, or based on information from, the conversational interface platform 104, for example. The interface 400 includes options to start a new conversation (block 402), enable plugins 106 (e.g., the DNS service provider plugin API 106′) (block 404), and chat (block 406). The plugins can include one or more plugins 106 (e.g., the DNS service provider plugin API 106′) that the user 102 can selectively enable/disable. In some embodiments, one or more of the plugins 106 (e.g., the DNS service provider plugin API 106′) can be automatically enabled based on the prompt 210. For example, if the user 102 enters a prompt 210 that states “Suggest a domain name for my new business” the domain service plugin may be automatically enabled. The plugins 106 can be one or more of a travel service plugin, a domain service plugin (e.g., the DNS service provider plugin API 106′), a weather service plugin, a restaurant table reservation service plugin, a grocery pick-up and delivery service plugin, and/or the like including combinations and/or multiples thereof).

In the chat (block 406), the user can enter the prompt 210 and receive the conversational response 216. In this example, the conversational response 216 includes a list of suggested domain names for “vegancupcakes” as shown. The chat (block 406) may also provide an indication to the user if a suggested domain name is available to be registered. For example, as shown in FIG. 4, the indication “(Available)” is placed after each suggested domain name that is available to be registered. As shown in FIG. 4, each suggested domain name is available to be registered. In one or more embodiments, the availability of one or more of the suggested domain names may be determined prior to providing the suggested domain names in the chat 406, and the indication may be provided in the chat 406 (as shown with the example in FIG. 4). In one or more embodiments, the availability of one or more of the suggested domain names may be determined after the suggested domain names are provided in the chat 406, and this determination may be automatic with the availability updated in the chat 406 or may be after the user has requested that the availability of one or more suggested domain names be checked.

The user 102 can then enter a follow-up prompt 210′ and receive a follow-up conversational response 216′. The follow-up prompt 210′ provides an opportunity for the user 102 to provide additional information or instructions to the conversational interface platform 104. The follow-up prompt 210′ can be used as a prompt to the conversational interface platform 104, which can then generate the follow-up conversational response 216′, using the system 300 shown in FIG. 3, for example. In this example, the conversational interface platform 104 provides a selection of registrars from which the user 102 can select to register a domain name. According to one or more embodiments described herein, the order of the presentation of the registrars can be controlled by the domain name service system (e.g., the DNS service provider plugin API 106′). For example, the DNS service provider plugin API 106′ can apply one or more rules for determining the order of presentation of the registrars. For example, the order can be determined using a round-robin approach, a random approach, an approach based on negotiated terms with the various registrars, and/or the like including combinations and/or multiples thereof.

The follow-up prompt 210′ provides an opportunity for the user 102 to provide additional information or instructions to the DNS service provider plugin API 106′ via the conversational interface platform 104. For example, the DNS service provider plugin API 106′ can associated an original prompt of the user 102 (e.g., the prompt 210) with a session and can maintain the session, such as for a period of time, or can associate the session with the user 102 based on a known or generated user identifier. The session enables the DNS service provider plugin API 106′ to maintain session-level knowledge/history which can be used to receive more information from the user 102, thus creating a feedback loop. This enables the user 102 to refine the prompt 210 (e.g., the original prompt) based on the conversational response 216.

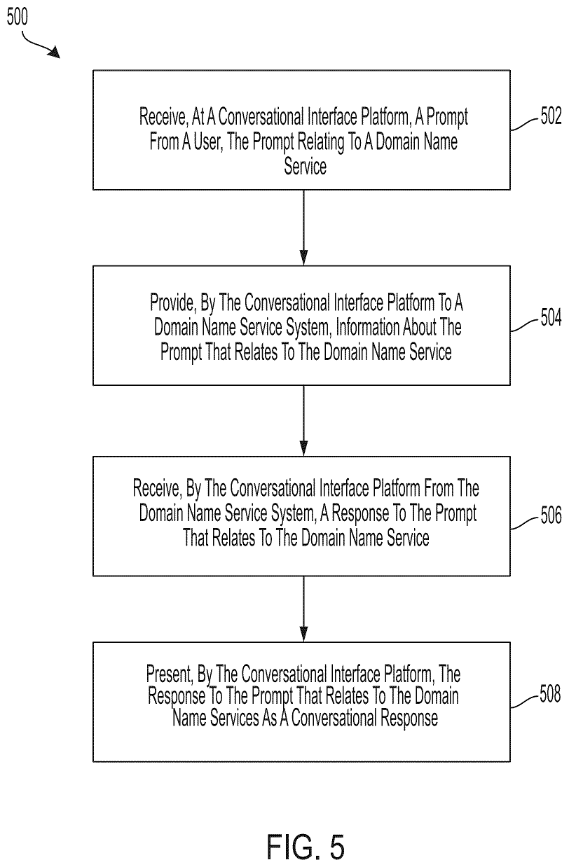

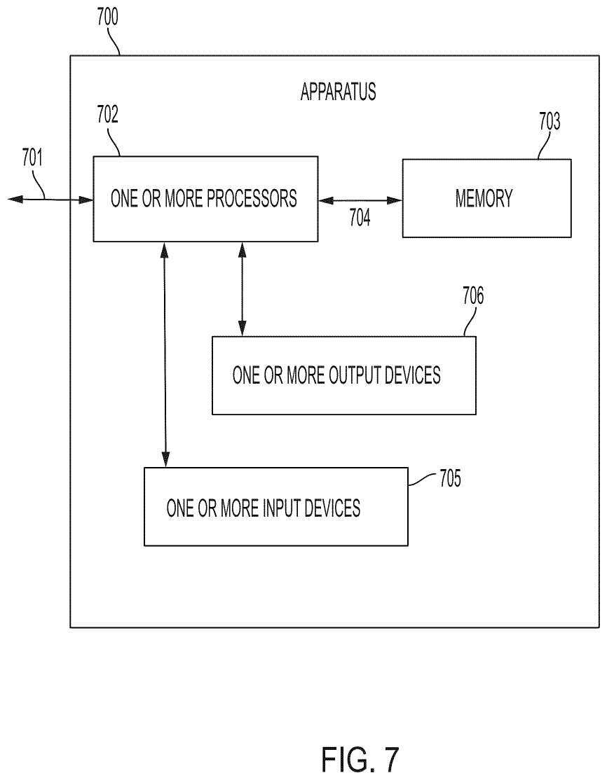

FIG. 5 depicts a flow diagram of a method 500 for providing domain name services for a conversational interface platform according to one or more embodiments described herein. The method 500 can be implemented by any suitable system or apparatus, such as a portion or all of the systems 100, 200, and/or 300 of FIGS. 1-3 respectively and/or the apparatus of FIG. 7. While an order of operations is indicated in FIG. 5 for illustrative purposes, the timing and ordering of such operations may vary where appropriate without negating the purpose and advantages of the examples set forth in detail throughout the remainder of this disclosure.

At block 502, the conversational interface platform 104 (e.g., a system providing a large language model (LLM)) receives a prompt (e.g., the prompt 210) that relates to a domain name service. For example, the prompt can request to register a domain name (e.g., “I want to register vegancupcakes.com”), can request recommendations for a domain name (e.g., “What are some domain names that are available for a vegan cupcake restaurant?”), can request information about a domain name (e.g., “Who owns vegancupcakes.com?”), and/or the like including combinations and/or multiples thereof. According to one or more embodiments described herein, the user 102 can use the interface 400 of FIG. 4 to input the prompt 210.

At block 504, the conversational interface platform 104 provides information about the prompt that relates to a domain name service (e.g., the DNS-related request 212) to a domain name service system (e.g., the DNS service provider plugin API 106′). In some embodiments, the conversational interface platform 104 provides the prompt itself, in addition to or instead of the information about the prompt. That is, the information about the prompt that relates to the domain name service can include the prompt itself and/or information extracted from or generated based on the prompt but not the prompt itself. For example, the conversational interface platform 104 can perform processing on the prompt using a LLM to extract information from or generate information based on the prompt, and the extracted or generated information is sent to the domain name service system (e.g., the DNS service provider plugin API 106′) instead of or in addition to the prompt 210.

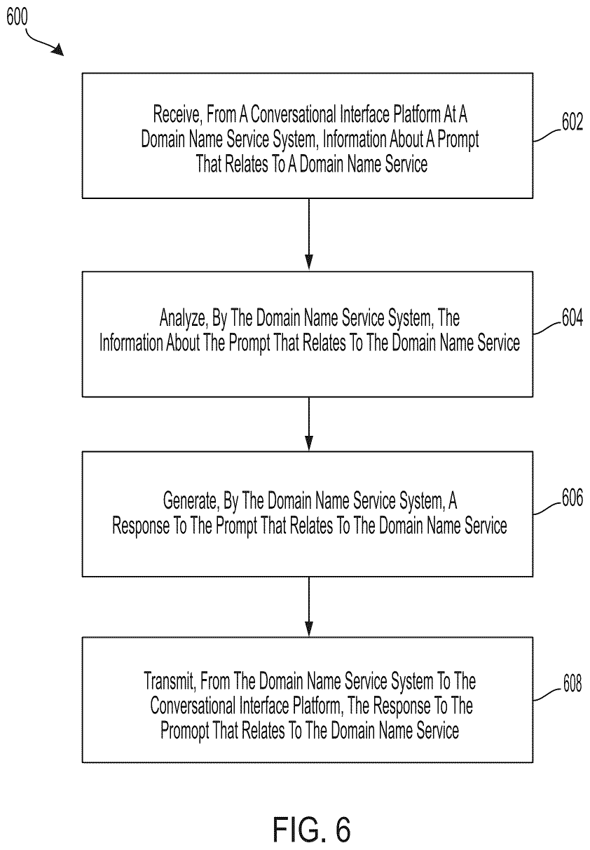

At block 506, the conversational interface platform 104 receives, from the domain name service system (e.g., the DNS service provider plugin API 106′), a response (e.g., the DNS-related response 214) to the to the prompt that relates to the domain name service. That is, the domain name service system (e.g., the DNS service provider plugin API 106′) analyzes the information about the prompt that relates to the domain name service and generates a response. The analysis and response generation are further described with respect to FIGS. 3 and 6, for example, as described herein.

At block 508, the conversational interface platform 104 presents the response to the prompt that relates to the domain name services as a conversational response (e.g., the conversational response 216). The conversational interface platform 104 generates the conversational response based on the prompt and the response to the prompt. For example, if the prompt requests information about a possible domain name, the conversational interface platform 104 may present, as the conversational response, a list of potential domain names, instructions for registering a domain name, links to a registrar that the user can use to register the domain, and/or the like including combinations and/or multiples thereof, in a conversational way. As an example, the conversational interface platform 104 may present information as shown on the interface 400 of FIG. 4 as the conversational response.

FIG. 6 depicts a flow diagram of a method 600 for providing domain name services for a conversational interface platform according to one or more embodiments described herein. The method 600 can be implemented by any suitable system or apparatus, such a portion or all of the systems 100, 200, and/or 300 of FIGS. 1-3 respectively and/or the apparatus of FIG. 7. While an order of operations is indicated in FIG. 6 for illustrative purposes, the timing and ordering of such operations may vary where appropriate without negating the purpose and advantages of the examples set forth in detail throughout the remainder of this disclosure.

At block 602, a domain name service system (e.g., the DNS service provider plugin API 106′) receives, from the conversational interface platform 104, information about a prompt (e.g., the prompt 210) that relates to a domain name service.

At block 604, the domain name service system (e.g., the DNS service provider plugin API 106′) analyzes the information about the prompt that relates to the domain name service. As shown in FIG. 3, for example, the domain name service system can include one or more of a multi-modal request handler 310, a context facilitator 311, a suggestion algorithm picker 312, and a multi-modal response handler 313. The multi-modal request handler 310 can parse, aggregate, and consolidate the information about the prompt that relates to the domain name service and generate a parsed, aggregated, and consolidated output. The context facilitator 311 can evaluate and supplement a context of the prompt. According to one or more embodiments described herein, the context facilitator 311 uses a context builder 314 to build additional context to supplement the context responsive to a determination that the context is insufficient. According to one or more embodiments described herein, the context builder 314 uses a large language model or a dataset to build the additional context to supplement the context. The suggestion algorithm picker 312 can select a suggestion algorithm from a plurality of selection algorithms, wherein the selection is based on a context of the prompt. According to one or more embodiments described herein, the domain name service system uses the selected suggestion algorithm to call a domain name search application programming interface (API) (e.g., the domain name search API 320) to perform an operation associated with the prompt. The operation can include one or more of searching for a domain name, generating a logo, suggesting a large language model, and/or the like including combinations and/or multiples thereof. The multi-modal response handler 313 can generate a multi-modal response to the conversational interface platform 104, where the conversational interface platform 104 generates a conversational response (e.g., the conversational response 216) based on the response from the multi-modal response handler (e.g., the DNS-related response 214).

At block 606, the domain name service system (e.g., the DNS service provider plugin API 106′) generates a response to the prompt that relates to the domain name service as described herein with respect to FIG. 3, for example.

At block 608, the domain name service system (e.g., the DNS service provider plugin API 106′) transmits to the conversational interface platform 104, the response (e.g., the DNS-related response 214) to the prompt that relates to the domain name service. The conversational interface platform 104 uses the response (e.g., the DNS-related response 214) to generate a conversational response (e.g., the conversational response 216), which can be presented to the user 102.

FIG. 7 depicts an example computer apparatus 700 for use with the embodiments herein. As an example, the computer apparatus 700 may be a computer to implement one or more embodiments described herein, such as providing domain name services for a conversational interface platform. For example, blocks 502 to 508 of FIG. 5 and/or blocks 602 to 608 of FIG. 6 may be performed by a computer, such as computer apparatus 700. The computer apparatus 700 may include one or more processors 702, a memory 703, one or more input devices 705, and one or more output devices 706.

Input to the apparatus 700 may be provided by one or more input devices 705, provided from one or more input devices in communication with the apparatus 700 via link 701 (e.g., a wired link or a wireless link), and/or provided from another computer(s) in communication with the apparatus 700 via link 701.

For example, based on input, the one or more processors 702 provide domain name services for a conversational interface platform. For example, the input is user input, such as the prompt 210. For example, the input may be from another computer in communication with the computer apparatus 700. For example, the input may be the DNS-related request 212. The input may be received in conjunction with one or more input devices 705 of the computer apparatus 700.

Output for the apparatus 700 may be provided by one or more output devices 706, provided to one or more output devices in communication with the apparatus 700 via link 701, and/or provided from another computer(s) in communication with the apparatus 700 via link 701. The one or more output devices 706 may include one more displays and one or more speakers.

For example, one or more output devices 706 may provide the status of the operation of embodiments as described herein, such as the DNS-related response 214 and/or the conversational response 216. The output device(s) 706 may provide visualization data according to certain embodiments described herein.

In some embodiments, one or more input devices 705 and one or more output devices 706 may be combined into one or more unitary input/output devices (e.g., a touch screen on a smartphone).

In some embodiments, based on input from one or more input devices 705 or input from outside the apparatus 700 via the link 701, the one or more processors 702 may perform operations as described herein. As an example, user input may be received from the one or more input devices 705. As an example, input may be from another computer in communication with the apparatus 700 via link 701. As an example, input may be from one or more input devices in communication with the apparatus 700 via link 701.

In some embodiments, the one or more processors 702 may perform operations as described herein and provide results of the operations as output. As an example, output may be provided to the one or more output devices 706. As an example, output may be provided to another computer in communication with the apparatus 700 via link 701. As an example, output may be provided to one or more output devices in communication with the apparatus 700 via link 701.

The memory 703 may be accessible by the one or more processors 702 (e.g., via a link 704) so that the one or more processors 702 may read information from and write information to the memory 703. The memory 703 may store instructions that when executed by the one or more processors 702 implement one or more embodiments of the present disclosure. The memory 703 may be a non-transitory computer readable medium (or a non-transitory processor readable medium) containing a set of instructions (or computer readable instructions, or processor readable instructions) thereon for providing domain name services for a conversational interface platform, wherein when executed by a processor (such as one or more processors 702), the instructions cause the processor to perform one or more methods discussed herein.

The apparatus 700 may be an apparatus for providing domain name services for a conversational interface platform, the apparatus including: one or more processors (such as one or more processors 702); and memory (such as memory 703) accessible by the one or more processors, the memory storing instructions that when executed by the one or more processors, cause the apparatus to perform one or more methods described herein.

The memory 703 may be a non-transitory processor readable medium containing a set of instructions thereon for providing domain name services for a conversational interface platform, wherein when executed by a processor (such as processor 702), the instructions cause the processor to perform one or more methods described herein.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

Embodiments illustrated under any heading or in any portion of the disclosure may be combined with embodiments illustrated under the same or any other heading or other portion of the disclosure unless otherwise indicated herein or otherwise clearly contradicted by context.

Numerous modifications, alterations, and changes to the described embodiments are possible without departing from the scope of the present invention defined in the claims. It is intended that the present invention is not limited to the described embodiments, but that it has the full scope defined by the language of the following claims, and equivalents thereof.

What is claimed is:

1. A computer-implemented method for providing domain name services for a conversational interface platform, the computer-implemented method comprising:
receiving, from the conversational interface platform at a domain name service system, information about a prompt that relates to a domain name service;
analyzing, by the domain name service system, the information about the prompt that relates to the domain name service;
generating, by the domain name service system, a response to the prompt that relates to the domain name service; and
transmitting, from the domain name service system to the conversational interface platform, the response to the prompt that relates to the domain name service.

2. The computer-implemented method of claim 1, wherein the domain name service system is a domain name system (DNS) service provider plugin application programming interface (API).

3. The computer-implemented method of claim 1, wherein the domain name service system comprises a multi-modal request handler to parse, aggregate, and consolidate the information about the prompt that relates to the domain name service and generate a parsed, aggregated, and consolidated output.

4. The computer-implemented method of claim 1, wherein the domain name service system comprises a context facilitator to evaluate and supplement a context of the prompt.

5. The computer-implemented method of claim 4, wherein the context facilitator uses a context builder to build additional context to supplement the context responsive to a determination that the context is insufficient.

6. The computer-implemented method of claim 5, wherein the context builder uses a large language model or a dataset to build the additional context to supplement the context.

7. The computer-implemented method of claim 1, wherein the domain name service system comprises a suggestion algorithm picker to select a suggestion algorithm from a plurality of selection algorithms, wherein the selection is based on a context of the prompt.

8. The computer-implemented method of claim 7, wherein the domain name service system uses the selected suggestion algorithm to call a domain name search application programming interface (API) to perform an operation associated with the prompt.

9. The computer-implemented method of claim 8, wherein the operation comprises one or more of searching for a domain name, suggesting a domain name, checking domain name availability, generating a logo, or suggesting a large language model.

10. The computer-implemented method of claim 1, wherein the domain name service system comprises a multi-modal response handler to generate a multi-modal response to the conversational interface platform, where the conversational interface platform generates a conversational response based on the response from the multi-modal response handler.

11. A system comprising:
a memory comprising computer readable instructions; and
one or more processors for executing the computer readable instructions, the computer readable instructions controlling the one or more processors to perform operations for providing domain name services for a conversational interface platform, the operations comprising:
receiving, from the conversational interface platform at a domain name service system, information about a prompt that relates to a domain name service;
analyzing, by the domain name service system, the information about the prompt that relates to the domain name service;
generating, by the domain name service system, a response to the prompt that relates to the domain name service; and
transmitting, from the domain name service system to the conversational interface platform, the response to the prompt that relates to the domain name service.

12. The system of claim 11, wherein the domain name service system comprises:
a multi-modal request handler to parse, aggregate, and consolidate the information about the prompt that relates to the domain name service and generate a parsed, aggregated, and consolidated output;
a context facilitator to evaluate and supplement a context of the prompt;
a suggestion algorithm picker to select a suggestion algorithm from a plurality of selection algorithms, wherein the selection is based on the context of the prompt; and
a multi-modal response handler to generate a multi-modal response to the conversational interface platform, where the conversational interface platform generates a conversational response based on the response from the multi-modal response handler.

13. The system of claim 12, wherein the context facilitator uses a context builder to build additional context to supplement the context responsive to a determination that the context is insufficient.

14. The system of claim 13, wherein the context builder uses a large language model or a dataset to build the additional context to supplement the context.

15. The system of claim 11, wherein the domain name service system uses the selected suggestion algorithm to call a domain name search application programming interface (API) to perform an operation associated with the prompt, wherein the operation comprises one or more of searching for a domain name, suggesting a domain name, checking a domain name availability, generating a logo, or suggesting a large language model.

16. A computer-implemented method for providing domain name services for a conversational interface platform, the computer-implemented method comprising:
receiving, at the conversational interface platform from a user, a prompt relating to a domain name service;
providing, by the conversational interface platform to a domain name service system, information about the prompt that relates to the domain name service;
receiving, by the conversational interface platform from the domain name service system, a response to the prompt that relates to the domain name service; and
presenting, by the conversational interface platform, the response to the prompt that relates to the domain name service as a conversational response.

17. The computer-implemented method of claim 16, wherein the prompt is selected from a group consisting of a request to register a domain name, a request for recommendations for a domain name, and a request for information about a domain name.

18. The computer-implemented method of claim 16, wherein the information about the prompt that relates to the domain name service includes the prompt itself.

19. The computer-implemented method of claim 16, wherein the information about the prompt that relates to the domain name service includes information extracted from or generated based on the prompt but not the prompt itself.

20. The computer-implemented method of claim 16, wherein the conversational interface platform generates the conversational response based at least in part on the prompt related to the domain name service and the response to the prompt related to the domain name service.
